(19) United States
(12) Patent Application Publication
(10) Pub. No.: US 2024/0104077 A1
(43) Pub. Date: Mar. 28, 2024

(54) DATA STORAGE METHOD, QUERY METHOD, ELECTRONIC DEVICE AND READABLE MEDIUM

(71) Applicant: BAIDU ONLINE NETWORK TECHNOLOGY (BEIJING) CO., LTD., Beijing (CN)

(72) Inventors: Weilong QUAN, Beijing (CN); Dong WANG, Beijing (CN)

(73) Assignee: BAIDU ONLINE NETWORK TECHNOLOGY (BEIJING) CO., LTD., Beijing (CN)

(21) Appl. No.: 17/768,614

(22) PCT Filed: May 6, 2021
(86) PCT No.: PCT/CN2021/091913

§ 371 Date: Apr. 13, 2022

(30) Foreign Application Priority Data
Dec. 7, 2020 (CN) 202011452209.3

(51) Int. Cl. G06F 16/22; G06F 16/2455; G06F 16/28

(52) U.S. Cl. CPC G06F 16/2282; G06F 16/24554; G06F 16/285

(57) ABSTRACT

Provided is a data storage method. The method includes bucketing tag data of all users based on user identifiers to obtain bucket data of each user, where tag data of each user is distributed in different tag tables; and storing bucket data of a same user in a same storage module.

This application claims priority to Chinese Patent Application No. 202011452209.3 filed with the China National Intellectual Property Administration (CNIPA) on Dec. 7, 2020, the disclosure of which is incorporated herein by reference in its entirety.

### TECHNICAL FIELD

The present application relates to the field of computer technologies, such as mini apps, big data, cloud computing and Internet technologies, for example, a data storage method and device, a query method, an electronic device and a computer-readable medium.

### BACKGROUND

Most mini apps are operated by traffic. A mini-app developer generally circles and selects user portraits and behavior characteristics on a developer platform to generate a specific crowd package in a targeted manner, and then accurately accesses to users in the specific crowd package.

In an actual operation process, the mini-app developer needs to create different types of tag data according to user behaviors. When there are a relatively large number of tag topics, multi-table associated queries are generally involved, resulting in large amounts of data being transmitted over the network.

### SUMMARY

A data storage method and device, a query method, an electronic device and a computer-readable medium are provided.

A data storage method is provided and includes steps described below.

Tag data of all users is bucketed based on user identifiers so that bucket data of each user is obtained, where tag data of each user is distributed in different tag tables.

Bucket data of a same user is stored in a same storage module.

A data storage device is provided and includes a plurality of storage modules.

The plurality of storage modules are configured to store tag data of all users, where bucket data of a same user is stored in a same one of the plurality of storage modules, tag data of each user is distributed in different tag tables, and the bucket data is obtained by bucketing the tag data of all users based on user identifiers.

A query method is further provided and includes a step described below.

In response to a tag query request, tag data of a user to be queried is obtained from bucket data of a same storage module, where the tag query request includes a user identifier used for identifying an identity of the user to be queried.

The bucket data is obtained by bucketing tag data of all users based on user identifiers; and bucket data of a same user is stored in a same storage module.

An electronic device is further provided and includes at least one processor and a memory communicatively connected to the at least one processor.

The memory is configured to store instructions executable by the at least one processor, which, when executed by the at least one processor, enable the at least one processor to execute the data storage method or the query method.

A non-transitory computer-readable storage medium storing computer instructions is further provided. The computer instructions are used for causing a computer to perform the data storage method or the query method.

### BRIEF DESCRIPTION OF DRAWINGS

FIG. 1 is a flowchart of a data storage method according to an embodiment of the present application;

FIG. 2 is a schematic diagram of a data storage method according to an embodiment of the present application;

FIG. 3 is a structural diagram of a data storage device according to an embodiment of the present application;

FIG. 4 is a flowchart of a query method according to an embodiment of the present application; and

FIG. 5 is a block diagram of an electronic device for performing a data storage method or a query method according to an embodiment of the present application.

### DETAILED DESCRIPTION

Example embodiments of the present application, including details of embodiments of the present application, are described hereinafter in connection with the drawings to facilitate understanding. The example embodiments are illustrative only. Description of well-known functions and constructions is omitted hereinafter.

A term “and/or” used herein includes any or all combinations of one or more listed associated items.

Terms used herein are only used to describe specific embodiments and are not intended to limit the present application. As used herein, singular forms “a” and “said” are also intended to include plural forms, unless the context dictates otherwise. When terms “comprise” and/or “made of” are used herein, the presence of features, wholes, steps, operations, elements and/or assemblies is specified, but the presence or addition of one or more other features, wholes, steps, operations, elements, assemblies and/or groups thereof is not excluded.

A mini-app developer circles and selects user portraits and behavior characteristics on a developer platform to generate a specific crowd package in a targeted manner, and then accurately accesses to users in the crowd package for the operation through traffic.

The developer platform needs to establish different types of tag data according to user behaviors, and each type of tag data is referred to as a topic domain. For example, the developer platform uses a user identifier (ID) as a unique identifier of a user and establishes basic attribute tag data, activity tag data and payment behavior tag data according to the user behaviors. The basic attribute tag data is basic attributes of the user, including, but not limited to, gender and points of interest of the user as described in Table 1.

TABLE 1
Basic Attribute Tag Table of the User

| Event date | User ID | Gender | Points of interest | . . . |
|---|---|---|---|---|
| 2020 Jan. 2 | User 1 | 1 | 1001 | . . . |
| 2020 Jan. 2 | User 2 | 0 | 1002 | . . . |
| . . . | . . . | . . . | . . . | . . . |
| 2020 Jan. 1 | User 1 | 1 | 1003 | . . . |
| 2020 Jan. 1 | User 2 | 0 | 1002 | . . . |

The activity tag data is behavior characteristics of the user opening the mini app, for example, the activity in the current day and the activity in the past 30 days, as described in Table 2.

TABLE 2
Activity Tag Table of the User

| | | Active or not in | Activity in | |
|---|---|---|---|---|
| Event date | User ID | the past 30 days | the current day | . . . |
| 2020 Jan. 2 | User 1 | 1 | 2 | . . . |
| 2020 Jan. 2 | User 2 | 1 | 3 | . . . |
| . . . | . . . | . . . | . . . | . . . |
| 2020 Jan. 1 | User 1 | 0 | 0 | . . . |
| 2020 Jan. 1 | User 1 | 1 | 1 | . . . |

The payment behavior tag data is payment behaviors of the user in the mini app, for example, the number of orders paid in the current day and whether there is a payment behavior in the past 30 days, as described in Table 3.

TABLE 3
Payment Behavior Tag Table of the User

| | | Whether there is | Number of | |
|---|---|---|---|---|
| Event | User | a payment behavior | orders paid in | |
| date | ID | in the past 30 days | the current day | . . . |
| 2020 Jan. 2 | User 1 | 1 | 2 | . . . |
| 2020 Jan. 2 | User 2 | 0 | 0 | . . . |
| . . . | . . . | . . . | . . . | . . . |
| 2020 Jan. 1 | User 1 | 1 | 3 | . . . |
| 2020 Jan. 1 | User 2 | 0 | 0 | . . . |

The storage of different tag data at a low layer is related and independent, that is, the storage of each tag table at the low layer is relatively independent, but tag data belonging to the same user in different tag tables are related. When query of the mini-app developer involves multiple tag topics of the user, multi-table associated queries are needed, so as to return a desired result.

For example, if the user uses 20200102 as the current query date, a user who is active in the past 30 days and whose gender is “1” is queried. This query requires an associated query of two tag tables based on the user ID, that is, an associated query of the basic attribute tag table and the activity tag table.

If the user uses 20200102 as the current query date, a user who is active in the past 30 days, whose gender is “1”, and whose the total number of orders paid in the past 7 days greater than is queried. This query requires an associated query of three tag tables based on the user ID, that is, an associated query of the basic attribute tag table, the activity tag table and the payment behavior tag data.

A tag table is set up according to the user behaviors, tag data of different user behaviors is stored in different tag tables, and different tag tables are stored in physical media at different positions at the low layer so that when associated queries are performed, a transmission amount of a data network is relatively large, and a query speed is relatively slow, thereby affecting the query performance. Moreover, with the refinement of service requirements, the number of tables in a database is rapidly increased, thereby increasing the complexity of service use and the cost of database maintenance.

The embodiments of the present application provide a data storage method. Through the data storage method, tag data of all users distributed in different tag tables can be stored locally and collaboratively, thereby reducing the transmission amount of network data and improving the query speed when the multi-table associated queries are performed.

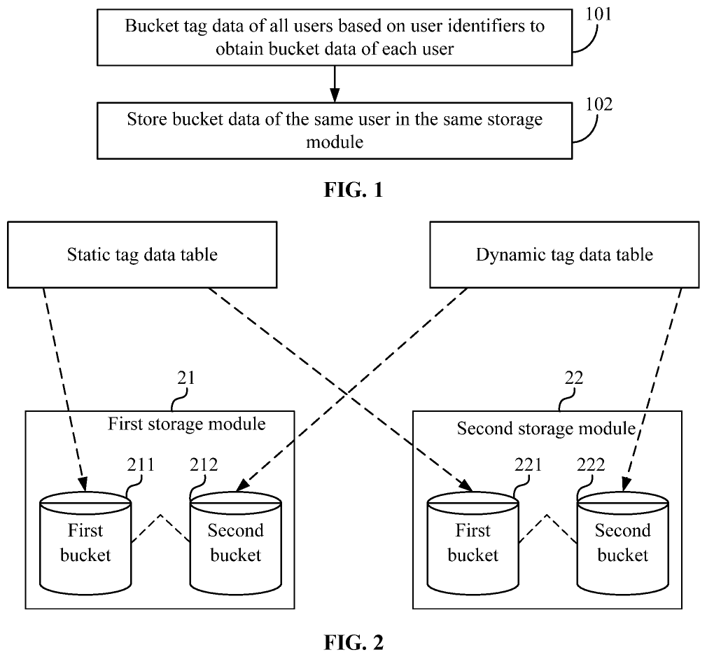

FIG. 1 is a flowchart of a data storage method according to an embodiment of the present application. FIG. 2 is a schematic diagram of a data storage method according to an embodiment of the present application. Referring to FIGS. 1 and 2, the data storage method provided in the embodiments of the present application includes steps described below.

In step 101, tag data of all users is bucketed based on user identifiers so that bucket data of each user is obtained.

The user ID is a unique identifier of an identity of the user, and the user can be distinguished and determined through the user ID. The user implements different behaviors in a process of using the network. Tags are added to these behaviors and a tag table is set up. Tag data in the tag table records the user behaviors. The tag table establishes corresponding relationships between user IDs and the user behaviors. The tags can expand analysis perspectives of service entities, and data filtering and analysis can be performed by operating on different tags.

Bucketing refers to bucketing tag data belonging to the same tag type according to the user identifiers and allocating tag data belonging to the same user in one bucket.

In some embodiments, the step of bucketing the tag data of all users based on the user identifiers to obtain the bucket data of each user includes classifying the tag data of all users according to tag types to obtain corresponding tag tables; and bucketing tag data in each tag table based on the user identifiers to obtain the bucket data of each user.

The bucket data is data allocated in one bucket, that is, a collection of different tag data belonging to the same user.

In some embodiments, the tag data is classified according to tag query modes, so as to generate the tag tables. For example, the tag types include a static tag and a dynamic tag, where tag data corresponding to the static tag does not change with time; and data corresponding to the dynamic tag changes with time. That is, the tag data includes static tag data and dynamic tag data. A static tag data table is set up according to the static tag data, and a dynamic tag data table is set up according to the dynamic tag data. The static tag data does not change with time and is a tag value of the user at a point in time. For example, the static tag data includes, but is not limited to, the basic attribute tag data and the activity tag data as described in Table 4.

TABLE 4
Static Tag Data Table of the User

| | | | Points | Active or | Activity | |
|---|---|---|---|---|---|---|
| Event | User | Gen- | of | not in the | in the | |
| date | ID | der | interest | past 30 days | current day | . . . |
| 2020 Jan. 2 | User 1 | 1 | 1001 | 1 | 2 | . . . |
| 2020 Jan. 2 | User 2 | 0 | 1002 | 1 | 3 | . . . |
| . . . | . . . | . . . | . . . | . . . | . . . | . . . |
| 2020 Jan. 2 | User 1 | 1 | 1003 | 0 | 0 | . . . |
| 2020 Jan. 2 | User 2 | 0 | 1002 | 1 | 1 | . . . |

The dynamic tag data changes with time and is a tag value of the user in a period of time. For example, the dynamic tag data includes, but is not limited to, payment tag data as described in Table 5.

TABLE 5
Dynamic Tag Data of the User

| | | Whether there is | Number of | |
|---|---|---|---|---|
| Event | User | a payment behavior | orders paid in | |
| date | ID | in the past 30 days | the current day | . . . |
| 2020 Jan. 2 | User 1 | 2 | 2 | . . . |
| 2020 Jan. 2 | User 2 | 3 | 0 | . . . |
| . . . | . . . | . . . | . . . | . . . |
| 2020 Jan. 1 | User 1 | 1 | 3 | . . . |
| 2020 Jan. 1 | User 2 | 0 | 0 | . . . |

In this embodiment, the tag data is classified according to the query modes, and a tag table is set up for each type of tag data. Compared with that tag tables are set up according to behavior modes, the number of tag tables can be reduced, thereby reducing the cost of database maintenance and the complexity of query statements; moreover, when the tag data is queried, the probability of the multi-table associated queries can be reduced, thereby increasing the query speed, improving the query performance, and effectively solving the problem of query performance in a super-large-scale data scenario.

For example, the static tag data table in Table 4 includes static tag data of all users, and the dynamic tag data table in Table 5 includes dynamic tag data of all users. Therefore, in the present application, merely two tag tables are used to classify a basic attribute tag, an activity tag and a payment tag. If the tag tables are set up according to the behavior modes, three tag tables are required. Therefore, in the present application, the number of tag tables is reduced.

In this embodiment, the tag tables are set up according to the query modes, thereby reducing the number of tag tables and avoiding the problem of the expansion of the number of tag tables in a refined operation process. Moreover, the reduction in the number of tag tables is also conducive to reduction in the complexity of query statements.

Referring to FIG. 2, the tag data in each tag table is bucketed based on the user identifiers. Static tag data of user 1 is allocated in a first bucket 211, and dynamic tag data of user 1 is allocated in a second bucket 212. The first bucket 211 and the second bucket 212 are disposed in the same storage module, that is, a first storage module 21. Tag data of other users is similar to the above. Tag data of the same user is stored in the same storage module and allocated in different buckets according to the tag types.

To achieve local collaborative storage, storage numbers of the first bucket 211 and the second bucket 212 are the same so that the tag data of the same user is stored in the same storage module.

In some embodiments, the step of bucketing the tag data of all users based on the user identifiers to obtain the bucket data of each user includes bucketing the tag data of all users through a hash algorithm based on the user identifiers to obtain the bucket data of each user.

For example, a hash operation is performed on each tag data according to the user IDs, remainders are taken so as to obtain bucket numbers, that is, the hash operation is performed on each record in the tag table, remainders of operation results are taken so as to generate a bucket number for each record. Tag data with the same bucket number is the tag data of the same user and stored in the same storage module.

In step 102, bucket data of the same user is stored in the same storage module.

In some embodiments, the bucket data of the same user is stored in the same storage module, that is, all tag data of the same user is stored in the same storage module.

Referring to FIG. 2, the storage module includes a first storage module 21 and a second storage module 22. Based on the user IDs, tag data of user 1 is stored in the first storage module 21 and tag data of the user 2 is stored in the second storage module 22.

For example, the first storage module 21 includes a first bucket 211 and a second bucket 212, where the first bucket 211 is configured to store tag data in a static tag table corresponding to user 1, for example, the first bucket 1 stores basic attribute tags and activity tags of user 1. For example, “user 1,20200102,1,1001,1,1” shows that the user ID is user 1, the date is Jan. 2, 2020, the gender is 1, the point of interest is 1001, the user is active in the past 30 days, and the number of active times in the current day is 1. The second bucket 212 is configured to store tag data in a dynamic tag table corresponding to user 1, for example, the second bucket stores payment tags of user 1. For example, “user 1,20200101,1,2” show that the user ID is user 1, the date is Jan. 1, 2020, there are payment behaviors in the past 30 days, and the number of payment times in the current day is 2.

In this embodiment, the case where two storage modules are provided is used as an example for description, but this does not mean that the present application can merely provide two storage modules. In fact, the number of storage modules may be any number greater than two.

In the embodiments of the present application, multiple storage modules are configured to store the static tag table and the dynamic tag table locally and collaboratively; moreover, tag data of the same user in different tag data tables is stored in one storage module so that when the multi-table queries are performed, the transmission amount of the data network can be reduced, and the query speed can be improved, thereby improving the query performance.

Storing the tag data of the same user in the same storage module does not mean that each user occupies one storage module, and the same storage module can store tag data of multiple users, as long as it is ensured that the tag data of the same user is stored in the same storage module, thereby ensuring that when the multi-table queries are performed, tag data of a user to be queried can be obtained from one storage module.

In some embodiments, at least one copy of tag data can be backed up on the same machine, that is, multiple copies of each tag table are set up for redundant storage to ensure security of the data.

In this embodiment, the case where two tag data tables are provided is used as an example for introduction, but this does not mean that the present application is only about processing with two tag tables. In fact, the data storage method provided in the embodiments of the present application can be applied to three or more tag tables. When multiple tag tables are queried in an associated manner, the transmission amount of the data network can be reduced, and the query speed can be increased, thereby effectively improving the query performance in the super-large-scale data scenario.

In the technical solutions in the present application, acquisition, storage and application of user personal information involved are in compliance with relevant laws and regulations and do not violate the public order and good customs.

In the data storage method provided in the present application, the tag data of all users is bucketed based on the user identifiers so that the bucket data of each user is obtained; tag data of each user is distributed in different tag tables, and the bucket data of the same user is stored in the same storage module. When multiple tag tables are queried in the associated manner, since bucket data belonging to the same user in different tag tables is stored in the same storage module, the tag data of the same user no longer needs to be transmitted over the network, thereby reducing the transmission amount of the data network, increasing the query speed, and effectively improving the query performance in the super-large-scale data scenario.

The embodiments of the present application provide a data storage device. The device stores tag data of all users distributed in different tag tables locally and collaboratively, thereby reducing the transmission amount of network data and improving the query speed when the multi-table associated queries are performed.

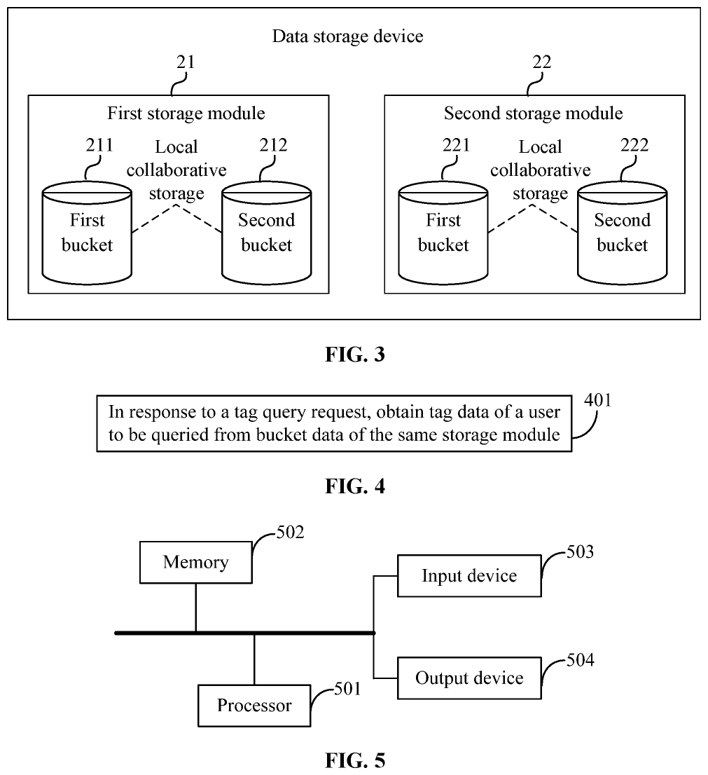

FIG. 3 is a structural diagram of a data storage device according to an embodiment of the present application. Referring to FIG. 3, a data storage device includes multiple storage modules.

The multiple storage modules are configured to store tag data of all users, and bucket data of the same user is stored in the same storage module.

Tag data of the user is based on the user identifier ID and records the record of behaviors of each user. The user ID is a unique identifier of an identity of the user, and the user can be distinguished and determined through the user ID. The user implements different behaviors in a process of using the network. Tags are added to these behaviors and a tag table is set up. Tag data records the user behaviors. For ease of recording, the tag data of the user is distributed in different tag tables. The tags can expand analysis perspectives of service entities, and data filtering and analysis can be performed by operating on different tags.

Bucketing data refers to grouping tag data in different tag data tables based on the user identifiers and allocating tag data belonging to the same user in the same tag table in a bucket. For the same user, different buckets can be obtained from different tag data tables, and the bucket data of the same user is stored in the same storage module.

In the embodiments of the present application, the storage device may be distributed on different physical nodes or disposed on the same physical node, or part of the storage device may be disposed on one physical node and another part of the storage device may be disposed on another physical node. In an actual application, the storage device may be disposed on one physical node or distributed on multiple physical nodes as desired.

In some embodiments, tag types are determined according to query modes, that is, the tag data is classified according to the tag query modes so as to generate tag tables, and tag data belonging to the same type is distributed in a tag table. For example, the tag data of all users is divided into static tag data and dynamic tag data according to the query modes, where the static tag data corresponds to a static tag data table and the dynamic tag data corresponds to a dynamic tag data table. The static tag data is a tag value of the user at a point in time and does not change with time. For example, the static tag data includes, but is not limited to, the basic attribute tag data and the activity tag data. The dynamic tag data is a tag value of the user in a period of time and changes with time. For example, the dynamic tag data includes, but is not limited to, the payment tag data.

In this embodiment, the tag tables are set up according to the query modes. Compared with that tag tables are set up according to the user behaviors, the number of tag tables can be reduced, thereby reducing the cost of database maintenance and the complexity of service use; moreover, when the tag data is queried, the probability of the multi-table associated queries can be reduced, thereby increasing the query speed and improving the query performance.

The data storage device provided in the embodiments of the present application includes multiple storage modules configured to store the tag data of all users, and the bucket data of the same user is stored in the same storage module. Therefore, when multiple tag tables are queried in the associated manner, the transmission amount of the data network can be reduced and the query speed can be increased, thereby effectively improving the query performance in the super-large-scale data scenario.

The embodiments of the present application provide a query method, thereby reducing the transmission amount of network data and improving the query speed when the multi-table associated queries are performed.

FIG. 4 is a flowchart of a query method according to an embodiment of the present application. Referring to FIG. 4, the query method includes a step described below.

In step 401, in response to a tag query request, tag data of a user to be queried is obtained from bucket data of a same storage module.

The tag query request includes a user identifier used for identifying an identity of the user. The user identifier (ID) is a unique identifier of the identity of the user, and the user can be distinguished and determined through the user ID.

Bucketing refers to grouping tag data belonging to the same tag type according to user identifiers. The bucket data is obtained by bucketing tag data of all users based on the user identifiers; and bucket data of the same user is stored in the same storage module.

In some embodiments, bucketing data refers to grouping tag data based on the user identifiers, allocating tag data belonging to the same user in the same tag table in a bucket, and storing buckets of the same user in the same storage module.

In some embodiments, the tag data is classified according to the tag query modes so as to generate tag tables, and tag data belonging to the same type is distributed in a tag table. For example, the tag data of all users is divided into static tag data and dynamic tag data according to the query modes, where the static tag data corresponds to a static tag data table and the dynamic tag data corresponds to a dynamic tag data table. The static tag data is a tag value of the user at a point in time and does not change with time. For example, the static tag data includes, but is not limited to, the basic attribute tag data and the activity tag data. The dynamic tag data is a tag value of the user in a period of time and changes with time. For example, the dynamic tag data includes, but is not limited to, the payment tag data.

For the dynamic tag data, when query is performed, it is feasible to implement dynamic aggregation through the time dimension, and a user corresponding to data that satisfies a value requirement within a specified query time range is a required user.

In this embodiment, the tag tables are set up according to the query modes. Compared with that tag tables are set up according to the user behaviors, the number of tag tables can be reduced, thereby reducing the cost of database maintenance and the complexity of service use; moreover, when the tag data is queried, the probability of the multi-table associated queries can be reduced, thereby increasing the query speed and improving the query performance.

According to the embodiments of the present application, the present application further provides an electronic device and a readable storage medium.

As shown in FIG. 5, FIG. 5 is a block diagram of an electronic device for performing a data storage method or a query method according to an embodiment of the present application. Electronic devices are intended to represent various forms of digital computers, for example, laptop computers, desktop computers, worktables, personal digital assistants, servers, blade servers, mainframe computers and other applicable computers. Electronic devices may further represent various forms of mobile apparatuses, for example, personal digital assistants, cellphones, smartphones, wearable devices and other similar computing apparatuses. Herein the shown components, the connections and relationships between these components, and the functions of these components are illustrative only and are not intended to limit the implementation of the present application as described and/or claimed herein.

As shown in FIG. 5, the electronic device includes one or more processors 501, a memory 502, and interfaces for connecting components, where the interfaces include a high-speed interface and a low-speed interface. The components are interconnected to each other by different buses and may be mounted on a common mainboard or in other manners as desired. The processor may process instructions executed in the electronic device, including instructions stored in or on the memory to make graphic information of a graphical user interface (GUI) displayed on an external input/output apparatus such as a display device coupled to an interface. In other embodiments, if required, multiple processors and/or multiple buses may be used with multiple memories and multiple memories together. Similarly, multiple electronic devices may be connected, and the multiple electronic devices provide some necessary operations (and, for example, serving as a server array, a set of blade servers or a multi-processor system). FIG. 5 shows one processor 501 by way of example.

The memory 502 is a non-transitory computer-readable storage medium provided in the present application. The memory stores instructions executable by at least one processor to cause the at least one processor to perform the data storage method or the query method provided in the present application. The non-transitory computer-readable storage medium of the present application stores computer instructions for causing a computer to perform the data storage method or the query method provided in the present application.

As a non-transitory computer-readable storage medium, the memory 502 is configured to store non-transitory software programs, non-transitory computer-executable programs and modules, such as program instructions/modules corresponding to the data storage method and the query method provided in the embodiments of the present application. The processor 501 executes non-transitory software programs, instructions and modules stored in the memory 502 to execute the various function applications and data processing of a server, that is, implement the data storage method or the query method provided in the preceding method embodiments.

The memory 502 may include a program storage region and a data storage region. The program storage region may store an operating system and an application required by at least one function. The data storage region may store data created based on the use of the electronic device for performing the data storage method or the query method. Additionally, the memory 502 may include a high-speed random-access memory and a non-transitory memory, for example, at least one disk memory, a flash memory or another non-transitory solid-state memory. In some embodiments, the memory 502 optionally includes memories disposed remote from the processor 501, and these remote memories may be connected, through a network, to the electronic device for performing the data storage method or the query method. Examples of the preceding network include, but are not limited to, the Internet, an intranet, a local area network, a mobile communication network and a combination thereof.

The electronic device for performing the data storage method or the query method may further include an input device 503 and an output device 504. The processor 501, the memory 502, the input device 503 and the output device 504 may be connected by a bus or in other manners. FIG. 5 uses connection by a bus as an example.

The input device 503 can receive input number or character information and generate key signal input related to user settings and function control of the electronic device for performing the data storage method or the query method. The input device 503 may be, for example, a touchscreen, a keypad, a mouse, a trackpad, a touchpad, a pointing stick, one or more mouse buttons, a trackball or a joystick. The output device 504 may be, for example, a display device, an auxiliary lighting device (for example, a light-emitting diode (LED)) or a haptic feedback device (for example, a vibration motor). The display device may include, but is not limited to, a liquid-crystal display (LCD), an LED display, or a plasma display. In some embodiments, the display device may be a touchscreen.

The various embodiments of the systems and techniques described herein may be implemented in digital electronic circuitry, integrated circuitry, an application-specific integrated circuit (ASIC), computer hardware, firmware, software and/or a combination thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input device and at least one output device and transmitting data and instructions to the memory system, the at least one input device and the at least one output device.

These computing programs (also referred to as programs, software, software applications or codes) include machine instructions of a programmable processor. These computing programs may be implemented in a high-level procedural and/or object-oriented programming language and/or in an assembly/machine language. The term “machine-readable medium” or “computer-readable medium” refers to any computer program product, device and/or apparatus for providing machine instructions and/or data for a programmable processor, such as a magnetic disk, an optical disk, a memory, or a programmable logic device (PLD). The term “machine-readable medium” or “computer-readable medium” includes a machine-readable medium for receiving machine instructions as machine-readable signals. The term “machine-readable signal” refers to any signal used in providing machine instructions and/or data for a programmable processor.

In order that interaction with a user is provided, the systems and techniques described herein may be implemented on a computer. The computer has a display apparatus for displaying information to the user, such as a cathode-ray tube (CRT) or an LCD monitor, and a keyboard and a pointing apparatus such as a mouse or a trackball through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. A client and a server are generally remote from each other and typically interact through a communication network. The relationship between the client and the server arises by virtue of computer programs running on respective computers and having a client-server relationship to each other.

Various forms of the preceding flows may be used, with steps reordered, added, or removed. For example, the steps described in the present application may be executed in parallel, in sequence or in a different order as long as the desired results of the technical solutions provided in the present application are achieved. The execution sequence of these steps is not limited herein.

1. A data storage method, comprising:
bucketing tag data of all users based on user identifiers to obtain bucket data of each user, wherein tag data of each user is distributed in different tag tables; and
storing bucket data of a same user in a same storage module.

2. The method of claim 1, wherein bucketing the tag data of all users based on the user identifiers to obtain the bucket data of each user comprises:
classifying the tag data of all users according to tag types to obtain a plurality of tag tables; and
bucketing tag data in each of the plurality of tag tables based on the user identifiers to obtain the bucket data of each user.

3. The method of claim 1, wherein tag types are determined according to query modes.

4. The method of claim 3, wherein the tag types comprise a static tag and a dynamic tag, wherein tag data corresponding to the static tag does not change with time; and tag data corresponding to the dynamic tag changes with time.

5. The method of claim 1, wherein bucketing the tag data of all users based on the user identifiers to obtain the bucket data of each user comprises:
bucketing the tag data of all users through a hash algorithm based on the user identifiers to obtain the bucket data of each user.

6-9. (canceled)

10. A query method, comprising:
in response to a tag query request, obtaining tag data of a user to be queried from bucket data of a same storage module, wherein the tag query request comprises a user identifier used for identifying an identity of the user to be queried;
wherein the bucket data is obtained by bucketing tag data of all users based on user identifiers; and bucket data of a same user is stored in a same storage module.

11. An electronic device, comprising:
at least one processor; and
a memory communicatively connected to the at least one processor, wherein the memory is configured to store instructions executable by the at least one processor, which, when executed by the at least one processor, enable the at least one processor to execute the following steps:
bucketing tag data of all users based on user identifiers to obtain bucket data of each user, wherein tag data of each user is distributed in different tag tables; and
storing bucket data of a same user in a same storage module.

12. A non-transitory computer-readable storage medium, storing computer instructions for causing a computer to perform the method of claim 1.

13. An electronic device, comprising:
at least one processor; and
a memory communicatively connected to the at least one processor, wherein the memory is configured to store instructions executable by the at least one processor, which, when executed by the at least one processor, cause the at least one processor to execute the method of claim 10.

14. A non-transitory computer-readable storage medium, storing computer instructions for causing a computer to perform the method of claim 10.

15. The electronic device of claim 11, wherein the at least one processor is configured to execute bucketing the tag data of all users based on the user identifiers to obtain the bucket data of each user by:
classifying the tag data of all users according to tag types to obtain a plurality of tag tables; and
bucketing tag data in each of the plurality of tag tables based on the user identifiers to obtain the bucket data of each user.

16. The electronic device of claim 11, wherein tag types are determined according to query modes.

17. The electronic device of claim 16, wherein the tag types comprise a static tag and a dynamic tag, wherein tag data corresponding to the static tag does not change with time; and tag data corresponding to the dynamic tag changes with time.

18. The electronic device of claim 11, wherein the at least one processor is configured to execute bucketing the tag data of all users based on the user identifiers to obtain the bucket data of each user by:
bucketing the tag data of all users through a hash algorithm based on the user identifiers to obtain the bucket data of each user.

19. The storage medium of claim 12, wherein the computer is configured to perform bucketing the tag data of all users based on the user identifiers to obtain the bucket data of each user by:
classifying the tag data of all users according to tag types to obtain a plurality of tag tables; and
bucketing tag data in each of the plurality of tag tables based on the user identifiers to obtain the bucket data of each user.

20. The storage medium of claim 12, wherein tag types are determined according to query modes.

21. The storage medium of claim 20, wherein the tag types comprise a static tag and a dynamic tag, wherein tag data corresponding to the static tag does not change with time; and tag data corresponding to the dynamic tag changes with time.

22. The storage medium of claim 12, wherein the computer is configured to perform bucketing the tag data of all users based on the user identifiers to obtain the bucket data of each user by:
bucketing the tag data of all users through a hash algorithm based on the user identifiers to obtain the bucket data of each user.
